(19) United States
(12) Patent Application Publication
(10) Pub. No.: US 2009/0035736 A1
(43) Pub. Date: Feb. 5, 2009

(54) Real-time training simulation system and method

(76) Inventors: Harold Wolpert, New South Wales (AU); David Wolpert, New South Wales (AU); Stephen Lee Wolpert, New South Wales (AU)

Correspondence Address: LADAS & PARRY LLP, 26 WEST 61ST STREET, NEW YORK, NY, 10023, US

(21) Appl. No.: 10/585,365

(22) PCT Filed: Jan. 17, 2005
(86) PCT No.: PCT/AU05/00051

§ 371 Date: Sep. 29, 2008

(30) Foreign Application Priority Data
Jan. 16, 2004 (AU) 2004900209

(51) Int. Cl. G09B 19/00

(52) U.S. Cl. 434/219

(57) ABSTRACT

A training simulation method and system for training operational service units such as call centre or customer service centres personnel are provided, including providing a simulated scenario to personnel, the scenario progressing in scenario time and the scenario including a plurality of simulated events provided in a predetermined sequence in real time at predetermined scenario times within the scenario, and receiving responses to the events from personnel. The system can simulate scenarios, which unfold to personnel in real time, and the responses of the personnel can be received in real time, so adding to the realism of the simulation being provided. The personnel responses can be marked and assessed to give a competency rating for their responses.

### FIELD OF THE INVENTION

The present invention relates to training systems and methods of training. In particular, the present invention relates to computerized real-time training or assessment simulations, particularly within operational service units such as call centres or customer service centres. Other individuals or groups of people can also be trained where a time-based, time critical assessment is required to validate learning.

### BACKGROUND OF THE INVENTION

Training is important in order for employees of a company to correctly carry out their duties. Assessment is a useful tool in ensuring that employees are correctly carrying out their duties, and is an important element of quality control. Some jobs are of high importance, and it is not desirable or possible for the training to be carried out in a real situation. However, training models can be effective in training the employee before they are faced with a real situation. However, such training is generally not realistic and may be divorced from the actual job in the employee's mind, so reducing the effectiveness of the training. Therefore, assessment of the training model does not necessarily reflect the ability of an employee within a real situation.

### SUMMARY OF THE INVENTION

According to aspects of the invention, there are provided a training method and a training simulation system for training personnel, preferably in emergency procedures within operational service units such as a call centre or customer service centre or the like, wherein a scenario is provided to the personnel that the personnel have to respond to. The training simulation or scenario may be made appropriate to any situation where the responses of staff to a progressing situation are required to be demonstrated. The personnel may be an individual person, or a group of people. The personnel may be one or more trainees.

In an aspect of the invention there is provided a training simulation method for training operational service unit personnel, the method including: providing a simulated scenario to personnel, the scenario progressing in scenario time, and the scenario including a stage provided in real time, the stage including a plurality of simulated events provided in a sequence in real time at predetermined scenario times within the scenario; and receiving responses to events from the personnel.

In a further aspect of the invention there is provided a method of designing a training scenario for provision for training personnel, the method including creating a plurality of events to be executed in a predetermined sequence at predetermined times according to a clock within the scenario, to produce the scenario to receive responses from personnel thereto, assigning a time for each of the events to occur within the scenario, and storing the designed scenario.

In a further aspect of the invention there is provided a training simulation system for training operational service unit personnel, the system including: a timing component to provide a real time clock, giving scenario time within a scenario, and time stamps according to that clock; a scenario simulating component to provide a simulated scenario to personnel, the scenario including a stage including a plurality of simulated events to be provided in a predetermined sequence in real time at predetermined scenario times according to the clock; and an input component to receive personnel responses to the events.

The scenario has a number of events within it. The scenario is preferably a simulation of a situation in which personnel have to respond to various events presented to them. The personnel may respond to the events by typing on a keyboard, by using a mouse, other pointing device or other means to interact with icons shown on a screen, or by submitting voice recording. Other suitable means of inputting user responses may also be employed. The scenario is preferably a virtual simulation, and is preferably provided on one or more computers, depending on the number of personnel involved in the simulation.

The scenario has at least one stage, or a plurality of stages, each stage including a plurality of events. The scenario preferably has an associated progress of time within it, or scenario time. Each event may occur at a predetermined scenario time within the scenario. Each event or stage may progress in real time. The scenario may include a plurality of stages, each stage representing a different period of scenario time within the scenario, and each stage being provided to personnel immediately after the previous stage, with a corresponding discontinuity in the progress of scenario time within the scenario between stages.

Each event may include a description of the event, provided to the personnel on a computer screen, or audio output or the like, to inform the personnel of the event. The events may also include one or more variables, which may affect how the scenario progresses, in particular, how the personnel should respond to the events. The variables may be made available to the personnel, or may interact with other variables to affect what is displayed to the personnel for the event within the scenario. The variables may include the scenario time within the scenario that the event should occur, and may also include details of what a correct response to the event would be. Other examples of variables include number of personnel on duty, calls in a queue, number of events taking place or other numerical or physical status that may affect the decision or outcome of a scenario. Events may also cause changes to the scenario, for example sending control commands to simulated applications, as discussed below.

At least some of the variables of at least some of the events may be affected by previous responses to previous events. However, other events may not be affected by any such previous responses.

The events may have durations in the scenario in which time the personnel must provide a response to the system, in order for it to be subsequently assessed. Such duration may recreate pressure situations, where personnel must provide responses under stress.

Responses to scenario may be entered during execution of the scenario by a single person, or by a group of people. The scenarios may have multiple roles, with different personnel being assigned different roles, within the same scenario. The responses for each role may affect subsequent events within a different role and/or within the same role. Personnel may only receive events marked for the role they have been assigned. The roles may be the roles ordinarily assigned to various employees within an organisation who are responding within the scenario. Alternatively, the roles may be assigned in order to test a new assignment of roles within an organisation. Each role of the scenario may be conducted concurrently on a separate computer all networked to a central scenario server. Alternatively, each role may be run on the same computer, which may be the scenario server computer, at different times. Further, the roles may all be shown in the correct interrelated times, for several personnel to respond to as a team, or individually on a single computer.

The scenario may also prompt for a response to be given, perhaps within a specified time limit, in order to recreate a real situation.

In a further form of the invention simulation applications are provided, which simulate a real-life software application or hardware device relevant to the simulation. In the case of simulation of a call centre, the simulation application may simulate a call centre screen that would ordinarily be seen by personnel while answering incoming telephone queries. Some or all of the events may be shown on the simulated call screen, for example if they relate to occurrences that would be shown on the screen in a real situation. The events may also be voice-synthesised output, and may also be shown on a dedicated event display separate to the application simulation. The responses to the events may be input into the simulated call centre screen, for example if the response is a part of the simulation, or may be entered into a separate dedicated response display, for example if the response is b comment regarding the event. The responses may also be voice based, for example to give a verbal instruction.

In a further form of the invention, at least some of the responses to the events made by the personnel are recorded. The recorded responses are preferably time stamped with the scenario clock Ume within the stage in which the event occurs. The recorded responses can be reviewed after the end of the scenario. The review may be an automatic comparison with a predetermined master response sheet, may be displayed for manual checking and marking, or may be a combination of the two. The reviewed answers may be analysed using visual tools, such as flow arrows that describe the relationship between trainee responses showing the direction of communication in each response, e.g. the initiator and recipient of a telephone call or messages broadcast to a department. Other visual tools may include time rulers, which show an overview of the progress of the scenario and mark where certain responses were received within the scenario, and associated zoom-in and zoom-out controls to allow review of a response at a particular point in the scenario quickly. The reviewed answers may be graded according to a predefined grade system, and the overall grade be used to certify the personnel as having achieved a predetermined level of competence.

A further aspect of the invention allows such a simulation scenario to be designed. An aspect of the invention allows scenarios to be designed for a large range of fields. These scenarios can be played back multiple times for the personnel. The personnel can respond to events that occur, entering their responses into the system, either as text, or by interaction with simulated applications. Once personnel have attempted a scenario, a designated assessor can then mark that scenario session, providing various types of assessment information for the various actions taken by the trainee during the scenario simulation. Preferably, personnel can subsequently review this assessment information, and reports can be generated based on the scenario attempts and their respective assessments.

Aspects of the present invention can be provided as software, hardware, or any other combination of the two, either as so called stand alone or networked versions.

### BRIEF DESCRIPTION OF THE DRAWINGS

Specific embodiments of the invention will now be described, purely by way of example, with reference to the accompanying drawings, in which:

FIG. 1 shows a schematic system according to an embodiment of the invention;

FIG. 2a shows a scenario design screen according to an embodiment of the present invention;

FIG. 2b shows a further scenario design screen according to an embodiment of the invention;

FIG. 3 shows a scenario execution screen according to an embodiment of the invention;

FIG. 4 shows a further scenario execution screen according to an embodiment of the invention;

FIG. 5 shows a diagram of the interaction of a scenario simulator of an embodiment of the invention;

FIG. 6 shows a flow diagram of the operation of the scenario simulator of an embodiment of the invention;

FIG. 7 shows a scenario marking screen according to an embodiment of the invention;

FIG. 8 shows a further scenario marking screen according to an embodiment of the invention;

FIG. 9A shows a further scenario marking screen according to an embodiment of the invention;

FIG. 9B shows a further scenario marking screen according to an embodiment of the invention; and

FIG. 10 shows a scenario assessment classification screen according to an embodiment of the invention.

### DETAILED DESCRIPTION OF EMBODIMENTS OF THE INVENTION

Components

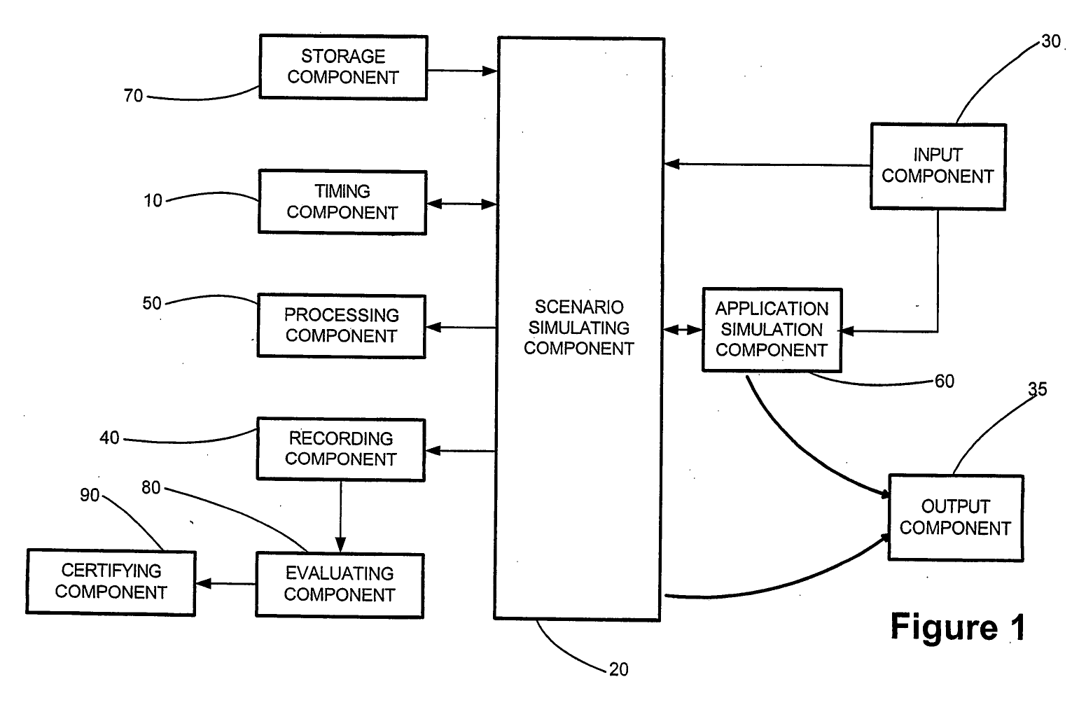

A schematic diagram of a training simulation system for training operational service unit personnel according to an embodiment of the invention is shown in FIG. 1. A timing component 10, is provided which provides a real time clock giving scenario time within a scenario and time stamps according to that clock. A scenario simulating component 20 is also provided, which provides a simulated scenario including at least one stage. The or each stage is provided in real time and includes a plurality of simulated events to be provided in sequence in real time, at predetermined scenario times according to the clock, to personnel. An input component 30 is also provided to receive personnel responses to events.

A recording component 40 is provided. The recording component 40 records responses from the personnel, together with time stamps generated by the timing component corresponding to the time of the respective response. A processing component 50 is provided, which processes responses and at least partially determines future events on the basis of the responses.

An application simulation component 60 is provided, which can provide a simulation of a software application or hardware device. The input component 30 then receives the personnel responses in a manner authentic to the software application or hardware device.

A storage component 70 is also provided. The storage component 70 stores instructions to produce the series of events of the simulated scenario in real time according to the dock of the timing component 10.

An evaluating component 80 is provided, which facilitates evaluation of the responses from the personnel. A certifying component 90 is provided to certify personnel as meeting a predetermined level of competence. The certification is based on a comparison of the evaluated responses with at least one determined grading level.

In embodiments, the system is provided on a computer. The components in embodiments of the invention are software components. However, it will be appreciated that various components could be implemented in hardware, firmware, or a combination. In embodiments, the scenario simulation is output to personnel via an output component 35 and is output to a display and/or audio speakers. The input component may receive inputs from a keyboard and a microphone and may also receive from other input devices that would be authentic to the scenario that is being simulated. In embodiments, at least part of the scenario simulating component 20 is run by a central server computer, which is connected to multiple client computers, each of which provides events corresponding to predetermined roles concurrently.

Scenario Creation

In an embodiment of the invention, a scenario for training call centre staff in the event of an emergency is designed using a scenario designer program. Situations of any length can be simulated within a scenario. Consequently a single scenario can span two months worth of occurrences, or can span five minutes, if the immediate response to a single event is all that personnel require training and/or assessment on.

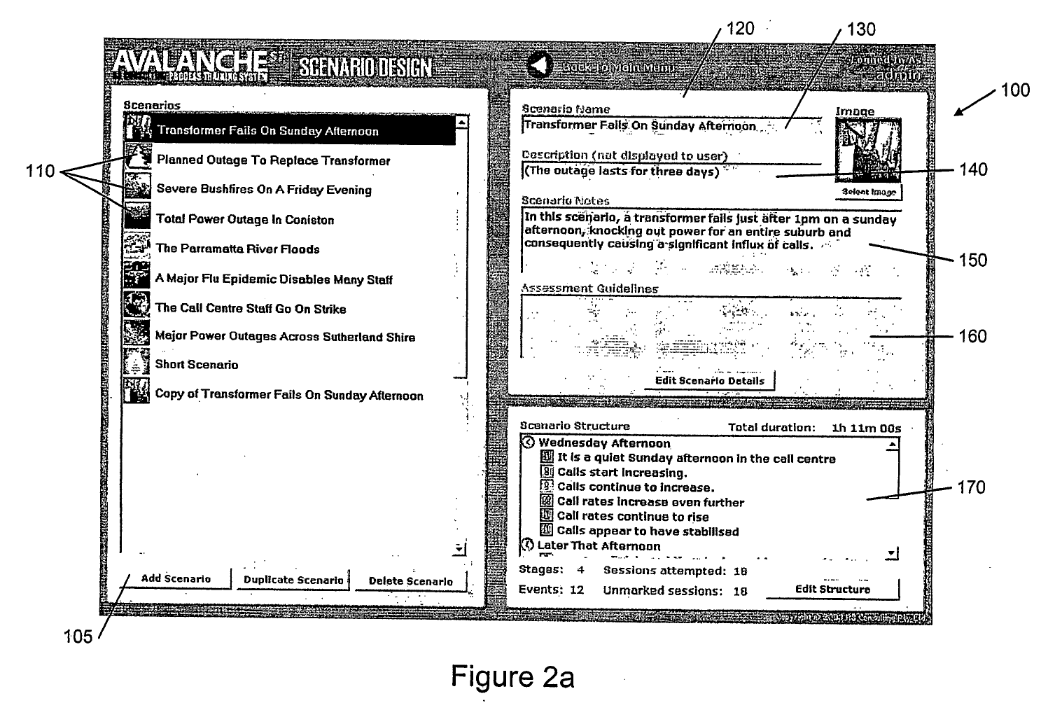

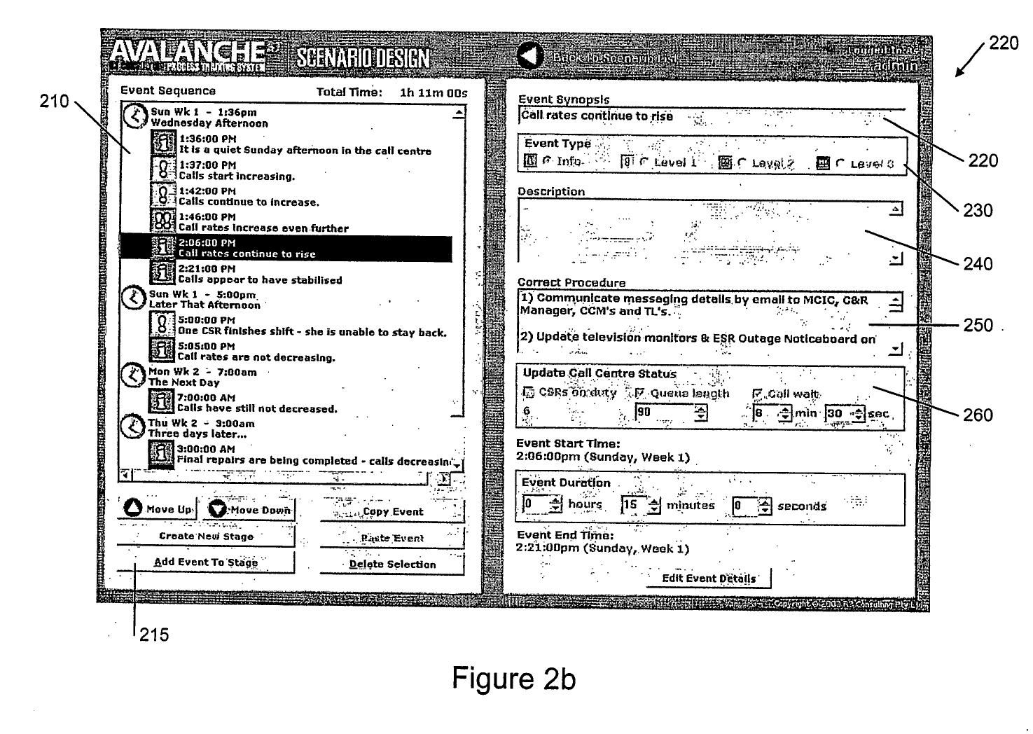

The scenario designer program allows for flexible layout of a sequence of events within a scenario. The scenario designer program may be executed on a standard computer. As shown in FIG. 2a, upon starting the scenario designer program, the designer is presented with a scenario overview screen 100. The scenario overview screen 100 presents the designer with a list of any already created scenarios 110, along with various items of information for each scenario 110. In order to create a new scenario, the designer uses the add scenario button 105.

On creating a new scenario, the following information is entered on a scenario entry area 120 in the scenario overview screen 100 containing fields 130, 140, 150, 160 for entering information relating to the scenario. The name by which the scenario 110 will be identified is entered in a scenario name field 130. The name is displayed to the user upon playback of the scenario, and is unique. Information solely for the designer is entered in a scenario secret description field 140. This information is never displayed to personnel during a simulation. Consequently, a scenario name may give an indication of the events that are about to unfold, only to surprise personnel with an unforeseen event. Mention of this unforeseen event can be placed in the secret description field.

For each scenario 110 a more detailed description can then be given of the scenario concept in the scenario notes field 150. This text is displayed to the personnel when they select a scenario for playback, so if an element of surprise is required for the training, then the scenario designer may choose to make these notes intentionally vague or misleading.

Scenarios 110 have a marking scheme that outlines the criteria by which marks, ratings and classification categories will be assigned when marking a session for this particular scenario 110. In the scenario design phase, details of this marking scheme can be added in the assessment guidelines field 160. A scenario structure field 170 is also provided, which gives a summary of a highlighted scenario 110.

Once the scenario overview fields have been completed, a scenario structure editor screen is displayed by selecting one of the scenarios 110. FIG. 2b shows such a structure editor screen 200, for a partially completed scenario.

The structure editor screen 200 is used to modify the flow of the chosen scenario. An event sequence window 210 shows events that have been added to the scenario, together with other information giving parameters and variables related to the event.

An event includes a description, a type, and various scenario variables and correct procedure information. Events are occurrences that affect the state of the scenario. Events may be displayed on a screen simulator and/or may be voice synthesised, acting to simulate the actual conditions that personnel would encounter if the event occurred in the workplace. Visually identical mock-ups of any piece of software can be provided as a simulation application. Depending on the level of customisation, the simulated applications can behave in the same or a similar manner to the application, normally used by personnel in their job, that is being simulated. Such simulation provides realistic navigation through software familiar to personnel, whilst detailed evidence of the personnel's movements through the simulated software is recorded, as described below, for later assessment.

An event synopsis is added in the synopsis field 220. Each event is then given a ‘type’ in event type input field 230. The type is a classification of the relevance of the event. In the default configuration, these types are “Info”, “Level 1”, “Level 2” and “Level 3” denoting the urgency of the event in question. Each event type has its own icon, allowing easy identification of significant events when playing out or marking sessions.

The event details are added in description field 240. The description gives the key information about the event. It consists of a text field where the designer can provide additional information about the event. For example, the synopsis entered into the synopsis field 220 for an event might be “The News Announces Major Bushfires In Sydney”, whereas the description field 240 might contain information of which suburbs are affected.

For each event in a scenario, the designer can provide details on the correct procedures that the personnel are expected to follow when this event occurs in correct procedure field 250. This information is presented to the assessor when they are marking a session, as discussed below, to assist them in their evaluation of the trainee's performance, but is not presented to the personnel during a simulation.

Various variables can then be added to the scenario, relating to each event, and how it interacts with other variables within the scenario. These variables are updated when the event takes place within the scenario. Therefore, the first event sets the initial state of the scenario. Alternatively, the initial state of the scenario may be set in a separate field, separate to any event creation or modification.

There are three types of event variables. Scenario-driven variables are independent of all other variables in the virtual world, and cannot be affected by actions or responses of the personnel in any way. They provide parameters of the scenario. In this call centre emergency training embodiment, it is appropriate that the average time of a phone call would be dependent on the type of emergency being simulated, but not dependent on the number of staff answering calls. Therefore, “average phone call duration” would be considered a scenario-driven variable and can be entered in variable input field 260.

Personnel-driven variables can be modified by the personnel as part of their response to scenario events. In this embodiment, the number of staff currently on duty may need to be increased by the personnel in response to an unexpected surge of calls. Therefore, “number of staff on duty” would be a personnel-driven variable. If automated assessment is to be employed, as discussed below, the correct procedure input by the designer may be a computer readable version of the correct personnel-driven variables to be input by personnel in response to the event.

Certain variables can be expressed as a function of one or more other variables. These are so called formula-driven variables. Combining scenario-driven variables and personnel-driven variables into a formula-driven variable can allow the system to portray the effects of personnel actions on the state of the simulation. In this embodiment, the average waiting time for callers could be expressed as a function of “the number of staff on duty” and “the average call duration”. In this case, “average waiting time” becomes a formula-driven variable, which is calculated by use of the appropriate scenario-driven variable entered during the design phase into field 260, and the use of the appropriate personnel-driven variable, received into the system from the personnel during play back of the scenario, as described below.

In one embodiment, the virtual world has a variable called “staff available to be rostered” and this variable decreases in response to an event “A flu epidemic strikes the city”. If, in an alternative embodiment however, staff are being trained at a hospital, a variable called “number of patients waiting in emergency ward” would be appropriate, which would rise in response to such an event.

As a further example, for an event “The entire city loses power”, for a call centre, this would mean that a variable named “number of calls in queue” would increase. However, for a simulation within a bank, a variable called “number of servers in operation” may decrease.

Each organisation, for which scenarios are designed, will have a number of pre-determined variables, and the scenario designer will allow these variables to be updated for each event. For each scenario-driven variable, the designer of the scenario can elect whether or not to update the variable's value for the event in question. If they decide not to, then the variable will remain unaffected by the event's occurrence.

For personnel-driven variables, the scenario designer program is able to update that variable's value at any stage, for example, by providing a value for the number of call staff on duty in variable input field 260. However, this will overwrite, at this point in the scenario, any changes previously made by the personnel. Consequently, this will rarely be done, except for the first event in a scenario, and occasionally the first event in a stage, in order to provide initial settings for the scenario or stage therein.

Formula-driven variables cannot have their values set in the scenario designer program, as their value is calculated automatically from the scenario-driven and personnel-driven variables, using customised formulae for each client.

As events are entered in the scenario designer program, they are inter-related. Each event is given a specific time within the scenario at which it occurs, and this time is set in the scenario designer program when creating a new event in the scenario, using button 215. In this way, it is possible for a scenario to progress through several events in a real time manner. Such real time event progress means that personnel cannot directly control when a particular event occurs, and they may not be prepared for the event, as might happen in a real situation. The real time progress of the events also creates a more realistic simulation of a scenario for personnel.

In some scenarios, the time of occurrence of the event may change, depending on whether a previous response is received, or on how the variables of the event are altered by previous responses. In other scenarios, if a response to a first event is not received, a subsequent event may not be displayed at all, for example, if the subsequent event is dependent on a previous response. Other events may only be shown if a response to a previous event is not received.

It is sometimes the case that a period of time is not relevant to the training, or it is desired to speed up the passage of time to compress a scenario into a shorter training session. Stages, where each event may be placed into a stage within the scenario together with other events, allow this to be accomplished by grouping a sequence of real-time events within a virtual time period. It may be desirable to skip a few minutes, hours or days in a scenario, by inputting a time gap between stages.

In order to accomplish this, two timeframes are used within the scenario. These are simulation time and scenario time. Simulation time corresponds to the real time from the point of view of the personnel carrying out the simulation, and gives the absolute time since a particular run of the scenario simulation started. So, for example, if the scenario simulation is 2 hours into a 3-hour training period, then the scenario simulation is at 2 hours of simulation time.

Scenario time refers to the time on a virtual clock within the scenario during the simulation—that is, the time that the simulator is representing at the current point in the simulation. Scenario times are represented as a week number (e.g. Week 2) plus a day of the week and a time. Within any given stage of the simulation, every second of the personnel's (simulation) time corresponds to a second of scenario time elapsing. This means that, effectively, events within a stage are occurring in real time. Each stage, however, has its own virtual start time (in scenario time), which allows a scenario to warp forwards in time when nothing relevant, i.e. no event, is to occur until then. For example, personnel may be provided with an hour to respond to something that occurs on a hypothetical Monday morning, only to immediately confront them with a further event that occurs on the Wednesday of that virtual week. Rather than have the personnel sit around for two days doing nothing, a new stage can be placed into the scenario after the events of the Monday, allowing scenario time to ‘jump forwards’ to the Wednesday.

To accomplish this, two stages are added to the scenario. The first stage starts Wednesday at 9 am, the second starting Friday at 12 pm. The Wednesday and the Friday are virtual times—the training session may actually be run at 4 pm on a Monday afternoon, but this is irrelevant to the two stages, which exist in scenario time.

Each stage has a start time (from which events run in real-time) and an optional synopsis describing the stage, which are added when creating a new stage, and can be subsequently amended. To avoid spoiling the surprise of this stage's events, synopses usually describe the reason for (or effect of) the time jump, rather than the contents of the stage. Some examples would be “Two days later”, “After the fire settles down”, “Once the evacuation is over and staff have returned”.

In scenario time, weeks start on Monday and finish on Sunday. Thus, the range of valid stage times start with 12:00 am on Monday, Week 1, then progress through to 11:59 pm on Sunday, Week 1, before rolling over to 12:00 am on Monday, Week 2.

This means if a scenario is started at 11 pm on Sunday, Week 1 and it lasts for 2 hours real-time, the second half of the scenario will occur very early on Monday, Week 2. Events are given start times according to scenario time, rather than simulation or real time. These times are entered in the structure editor screen 200.

Each event within a stage is also given a duration as one of the variables. The duration is the amount of time personnel are to have to respond to the event in question before a subsequent event is presented to them. By the end of this event, the scenario clock will have moved forward by the event duration in real-time, and thus the “scenario time” of a given event can be calculated as the scenario time of its stage plus the real-time durations of all the events prior to it within the stage.

The duration of an event may give a limited time in which personnel can respond to that event. Such time limitations place pressure on personnel, and the responses given while under that pressure can be reviewed. The event variables may include instructions to disregard any response given outside the duration of the event, or may mark responses outside the event as being received as such. The simulator may also be designed to prompt for a response from personnel, if the prompt would be given in the real situation in order to make the simulation realistic. The prompts may be made, for example, if a particular response is not made in a particular event duration; a message showing this could be shown on the screen to personnel. Alternatively, an alarm message could be sent to a notional or real further personnel, and the alarm message and instructions of under what conditions it should be sent would be stored as variables within the event.

The simulation times, scenario times and durations of events may be based on timers provided by the computer on which the scenario simulator is running. The durations can be measured simply as a time difference; the simulation times as a stopwatch set running at the beginning of a scenario, and paused while a scenario is stopped, to continue timing from the time the scenario was interrupted, when the same scenario is continued. The scenario time can be calculated by the elapsed time since the beginning of the last stage, at which point the scenario time would have been automatically updated.

Audio recording tools may be provided, which the simulated applications can take advantage of in a way that matches a particular software package's means of recording. Audio recordings are useful to allow an assessor to hear a message recorded by the personnel (for example, a periodic voice-over message to playback over an airport's public address system during a blizzard).

The order of events within a scenario may be altered in order to vary the progress of the scenario. Therefore, the designer program provides buttons to move events up and down, allowing the trainer to easily reorder events within a stage. If the scenario designer decides that the third event within a stage should actually happen before the event that is currently second in the stage, they select the third event and press the “Move Up” button. The duration of all events remains the same—only the ordering is changed. Similarly, the “Move Down” button requests that an event will occur one step later in the stage.

To facilitate the easy repetition of an event with small changes, and to allow an event to be replicated in another stage, it is also possible to copy an event from a stage and paste it to another stage as desired. Events can also be pasted to the same stage as a clone if required.

As a quick preview of the types of events that occur in the selected scenario, a scrollable list of stages and events is shown for the selected scenario in the scenario structure field 170 of FIG. 2a, once they have been added to the scenario using the scenario structure editor 200 of FIG. 2b.

Sometimes it is not convenient to describe a sequence of events in terms of event duration. For example, if a scenario is modelled based on a real-life event that occurred, the actual time information of each event may be available. In such cases, the designer can add each event without worrying about their times, then subsequently go through each event and set the scenario time of that event. The time editor allows a scenario time to be chosen for a given event, requesting that previous and subsequent events either change their durations to accommodate (keeping the stage length the same) or maintain their durations (resulting in the stage length growing or shrinking accordingly).

In an embodiment, the events input by the designer are all allocated to a single user (the personnel) of the scenario simulator using a single computer, which is called a single-user scenario. The same single user scenario may be provided to multiple personnel separately, and the results from each of the personnel compared during assessment. However, in an alternative embodiment the personnel may be a team of people. In this case, the events may be made specific to a particular person, each person using a separate networked computer in a multiple-user scenario, or running the simulation separately. In this case, each person within the personnel has a different role, and each event can be assigned to one or more of the roles by the designer using a suitably configured designer program, with responses only from those roles being required. In this case, failure of one person to respond to one of their events may produce a message on the screen corresponding to another role. This may be as a further event, stating that something (the response) was not completed or may be acted on as part of the same event, dependent on whether or not a response is provided. Alternatively, all events may be visible to all roles, and the choice of whether to respond to an event made by each individual person within the personnel being trained.

These roles can either be globally set for a particular organisation whose personnel are using the scenario simulator, or they can be set on a per-scenario basis, using a roles editor provided in the scenario design program. Such a roles editor could simply display the available roles, and provide tick boxes for the currently selected event. Each role that an event should apply to can then be selected by checking the tick box.

Often a trainer may wish to train personnel to handle a number of scenarios that differ only slightly from each other. To aid this, a scenario may be cloned, i.e. a scenario and all of its stages and events are copied into a new scenario.

Scenario Playback

All users of the system (trainers, personnel, administrators, management) start the software in the same way, by logging in with their username and password. Depending on their account status (i.e. permissions) they will be able to access some features of the system and not able to access others. Each user has a password, which is encrypted and stored in the database. Passwords can never be retrieved or viewed. However, an administrator can replace a user's password if necessary. The level of permissions is configurable on an organisation-by-organisation basis. In the current embodiment, discreet permissions for designing scenarios, playing scenarios, marking scenarios and administration are provided. However, further or fewer discreet permissions may also be provided as appropriate.

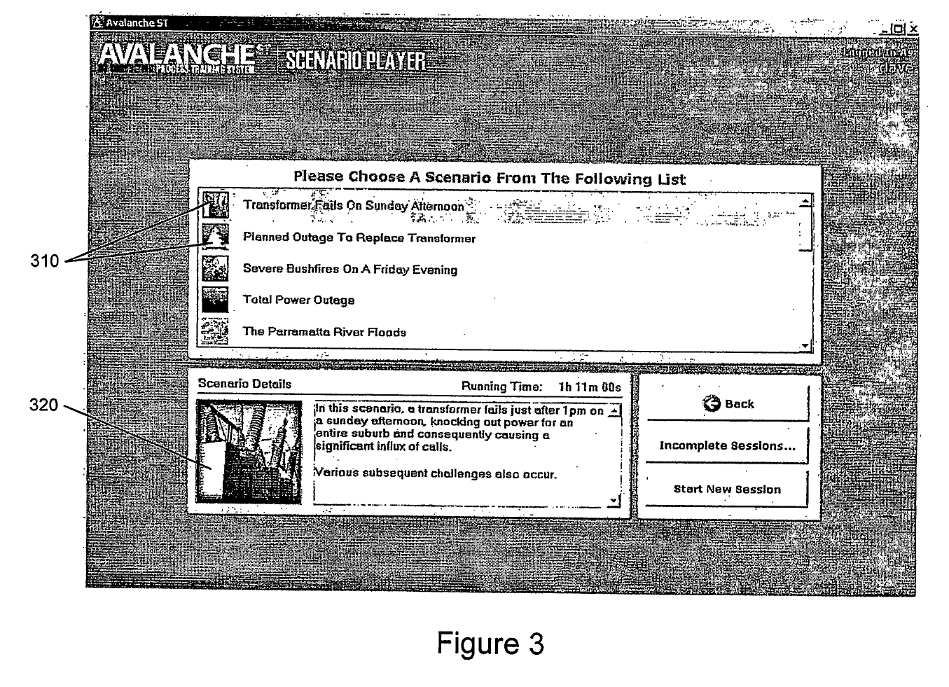

FIG. 3 shows a first screen of a scenario simulator according to an embodiment of the invention. One or more standard computers may carry out the scenario simulation execution depending on the number of personnel involved, as discussed below. In the present embodiment, the standard computer(s) provides, together with appropriate software, a timing component to provide scenario time, simulation time and real time details for use with the simulation, a scenario simulating component, which provides the scenario to the personnel, and also an input component for receiving responses from the personnel to events in the scenario. The scenario simulator includes one or more scenarios created as described above. Each scenario 310 is independent of the others. A training supervisor, who is in charge of the running of the simulation scenario, can choose any of the scenarios 310 to proceed with and simulate.

Scenario details are provided, giving further information on the content of the scenario in a scenario detail box 320. The information given in the scenario detail box corresponds to that input in the scenario notes field 150 of FIG. 2a, discussed above, during creation of the scenario.

Roles function differently in the single-user and networked versions of the scenario. In the single-user version, one person at a time is ‘driving’ the scenario and consequently the role of the person responding to an event must be specified before that response can be submitted. The scenario simulator provides a selection box, from which personnel (or a training supervisor) select the role of a person prior to entering their response to an event. A single computer may therefore be used to provide the scenario both to the person being trained, and the training facilitator.

In the networked, multi-user version of the scenario simulator, personnel do not create their own training sessions. Instead, the training supervisor creates a training session and the personnel each join the training session before the supervisor starts the scenario. At the time of joining the session, personnel are automatically assigned the role defined in their profile. Alternatively, personnel may choose a role from the list of available roles (or, if permitted, can add a new role). Subsequently, all of their actions are linked to their role as well as their user name. The role of the person will also define which events in the scenario are shown to the person, along with other changes to the scenario such as which simulated applications are available, which people (other roles) they can interact with, and what actions can be submitted. Each of the personnel uses a separate computer, networked to a central scenario server, which the training supervisor uses to control the progress of the scenario.

Each time personnel attempt a particular scenario a new session is created. The session is effectively an attempt at the scenario, and consists of all the events that occur during the simulation, including all actions performed by the personnel in response to the events unfolding.

Each response from the personnel is called an action. An action can be as simple as a text description of the response approach entered into the scenario simulator using a keyboard, or it can be a series of mouse clicks on a virtual application, for example. Any other suitable input methods can also be used. Each response for an event is recorded as data on the computer, acting as a recording component, and cross-referenced with the event that it was a response to together with a time stamp, giving both the scenario time and the simulation time that the response was entered.

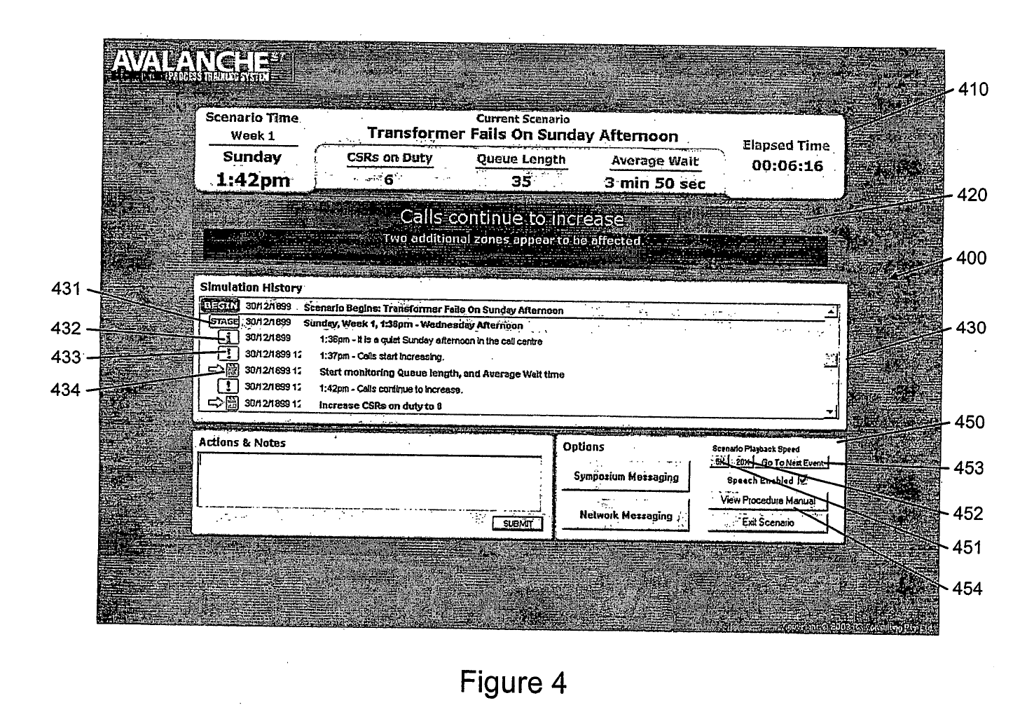

FIG. 4 shows a second screen 400 of a simulator according to the embodiment once a particular scenario has been chosen. In this case, the scenario is called “Transformer Fails On Sunday Afternoon”. The figure shows several regions of the display. A scenario status area 410 is displayed at the top of the screen. An event details area 420 is also provided below the scenario status area 410. A simulation history area 430, which shows previous events within the stage is shown in the lower mid-screen. A personnel response area 440, which allows personnel responses to the events to be input, is shown at the bottom of the screen and a scenario control area 450 is shown at the bottom right of the screen, next to the personnel response area 440.

The scenario status area 410 displays all information about the scenario and the simulated world. Specifically, here the personnel taking part in the simulation can view the following information: the scenario name, the current time into the simulation (simulation time), the current time in the virtual world (scenario time); and the status of all the variables within the scenario.

The event details area 420 shows the details of the most recent event that has occurred. These details correspond to the information entered into the event description field 240 shown in FIG. 2b when creating the scenario. In large text, the event synopsis, corresponding to the information added in event synopsis field 220 of FIG. 2b during creation, is shown, and below that in smaller text, the event details can be found.

Events appear in the event details area 420 and flash in a highlighted colour for a few moments to alert the user that something new has occurred. The event details area 420 is also used when a new stage is encountered, displaying the stage synopsis and new scenario time. Additionally, for the beginning and end of a scenario, this area is used to display the relevant messages.

During a simulation, the synopsis of each event will be displayed to the personnel, and the computer uses speech-synthesis to announce these synopses. At the same time, the more detailed description entered into the description field 240, described above in relation to FIG. 2b, will be displayed, but this is not announced (unless it is desired for this to be the case).

Some events may have a limited duration in which responses can be made by personnel. Such time restrictions place pressure on personnel, and so their responses while under pressure can be assessed.

In addition to the features described with regard to the present embodiment, it is also possible to include the ability to trigger customised animations and sound effects with each new event. Such animations can use the event details area 420 to illustrate the event's effect (e.g. an animation of the city blacking out, a bushfire, or an electrical storm, or someone reading the News report announcing a relevant situation to affect the event).

The simulation history area 430 displays a scrollable history of everything that occurs during a simulation session. This includes all scenario stages 431, events 432 and 433 and other notes, as well as all user actions 434, user notes, audio recording submissions, simulated-application interactions and session interruptions. Each different type of occurrence has a specific icon to identify that type of occurrence easily.

The personnel response area 440 is the region on the screen into which the personnel can type either their direct response to the events of the scenario or a synopsis of what they would carry out in such a situation. After they have typed a description of their action, they press <enter> on their keyboard or click the “submit” button, and that action is posted to the session history and time-stamped with the current simulation time. As described above, the responses to an event may in part determine further event variables, the effect being determined by the computer running suitable software to act as a processing component for processing the responses to determine the further event variable(s).

The scenario control area 450 provides a number of features that allow the user to interact with the scenario, change settings and obtain information. These features include speed controls 451, 452, 453. The “5×” button 451 increases the playback speed five times; the “20×” button 452 increases the playback speed twenty times and the “Go to next event” button 453 jumps immediately to a time just before the next event is to be revealed. These speed control buttons 451, 452, 453 are useful when a training group or personnel has completed everything they intend to do in response to a given event and would like to get to the next event more quickly. Here the user can decide whether they want new events to be announced, or whether instead they wish to be alerted by a beep. It is also possible to provide more fine-grained control over sounds and notifications, as required.

The ‘view procedure manual’ button 454 provides the personnel with access to the scenario process documentation as a reference. This documentation is provided e.g. by the employer company and is converted to HTML format or another appropriate soft format before commencement of the training.

When the personnel presses the ‘view procedure manual’ button 454 to access the procedure documentation, a note is added to the session history that this is the case, as the assessor may find this relevant in assessing the performance of the personnel in the simulation. Additionally, in other embodiments, any relevant interactions with the procedure manuals or help files (such as which particular pages are viewed etc) may be tracked and added to the session history. This will allow monitoring and analysis of the behaviour of people being trained to use those resources. The level of detail of this tracking—i.e. which interactions are recorded—may be defined during scenario design.

Additionally, simulated applications may be provided using the computer as an application simulation component, depending on the scenario in use. These are effectively interactive applets that replicate the appearance and behaviour of another piece of software or other entity with which interaction is possible. Simulated applications send messages (containing any relevant activities carried out) to the simulator, which in turn submits these messages as user actions in the current session. The complexity of the interactive applet can be increased to suit the required level of accuracy for the simulated application.

Other buttons (not shown) can be added to the scenario control panel 450 to allow access to whichever simulated applications have been customised for a given scenario or group of scenarios for a particular organisation. For example, the simulated application may be the call centre display for handling incoming telephone calls. The simulated application, when run, preferably hides the personnel response area 440, most of the simulation history area 430, and the scenario control area 450 and replaces these areas with the selected simulated application.

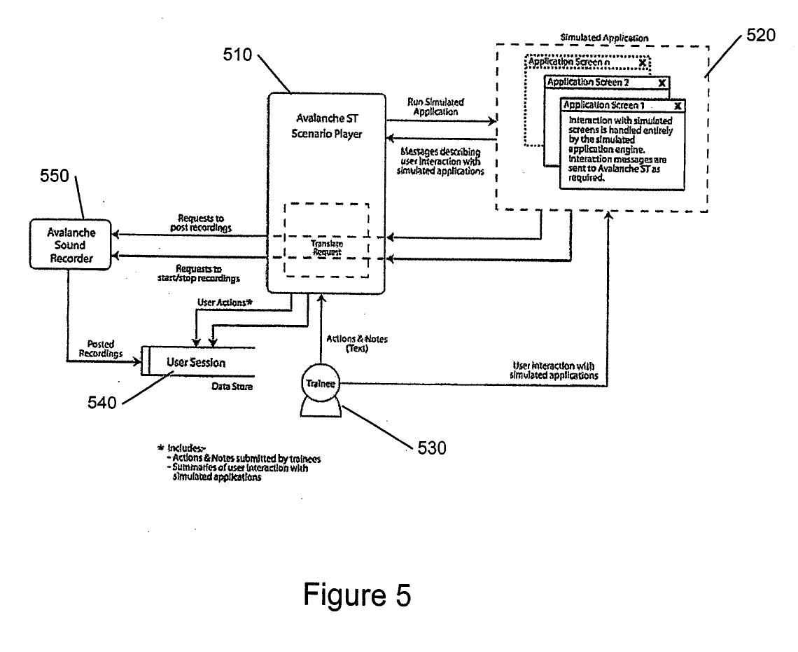

FIG. 5 shows the interaction of the simulator with the personnel and simulated applications for a single-user typo scenario, in which a single computer is used to provide the scenario. The scenario simulator 510 runs one or more simulated applications 520 when requested by the personnel 530. The simulated application(s) 520, receive inputs from the personnel 530, and the interaction of the personnel with the simulated application(s) are passed back to the scenario simulator 510. During a simulation, some events might contain information that triggers the dispatch of commands by the scenario simulator 510 to control other aspects of the simulation, for example the simulated application(s) 520. Actions and texts can also be entered by the personnel 530 directly into the scenario simulator 510. The direct inputs and interaction reports from the application simulator(s) are forwarded to a recording device 540, which in the present embodiment is a computer disk-drive, for later evaluation.

The scenario simulator 510 also activates a sound recorder 550 at appropriate instances according to instructions when various events, containing instructions to receive sound input, occur. These recorded sounds from the personnel 530 are also recorded on the recording device 540 as an input component, in which all entries are cross-referenced in a database stored in the recording device 540 with the event they are in response to. Alternatively, the sound recording may be part of the simulated application itself, and the recorded sound data passed from the simulation application to the scenario simulator for subsequent passing to the recording device. Audio recordings allow for assessment of such things as emergency announcements, answering machine or IVR messages, verbal instructions to other personnel, or other role-play phone calls made to hypothetical people—that is, situations where the way a message is spoken is relevant as well as what is spoken. These inputs may be stored along with information about the relationship between the inputs, for example both sides of the telephone call in real time, or review of the recordings of each individual telephone call participant. In other embodiments, any other input may be used for recording, for example, video recording.

A simulated application can be implemented in various ways, and using various development tools. In the present embodiment, the simulated applications use an ActiveX interactive presentation player. The communication with the simulated applications is through the standard ActiveX scripting mechanism. However, the simulated applications can be anything from a simple HTML screen presentation (with hotlinks to move to other screens) to an actual functioning application written in C++ (or any other language, or implemented as, for example, a Java application for internet use). The only requirement is that the simulated applications must have ‘hooks’—that is, points in their operation where a message can be sent to the scenario simulator 510.

It is also possible to make use of, for example, TCP socket communication, allowing the actual applications used by an organization having personnel to be trained to have scenario simulator communication added to the actual applications used by personnel. In this case the actual software used by the organisation would be used by the application simulation component. The simulator could also be used to activate certain “time critical” processes via these ‘hooks’ into the live application to prompt personnel what to do as their next task in any process. Simulation variables can have values provided to them from these applications. Such use of the actual software run by an organisation in a simulation environment adds to the realism of the simulation. The actual software may be automatically activated where a response is not received within a certain period, as described above. This could also allow the extension of simulated applications to include the organization's intranet websites.

When personnel 530 finish with a simulated application 520 and they choose to exit that application 520, the screen space taken up by the simulated application is returned to its original state, with the full action history, personnel response area and scenario control area visible again.

In the single-user version, prior to any action being submitted, the role of the person undertaking that action is first selected. This can be done on the personnel response area 440, (shown in FIG. 4, and discussed above) using the roles drop-down combo box or, if running a simulated application, in the simulated application area. Each action submitted to the database will be flagged with both the username and role specified.

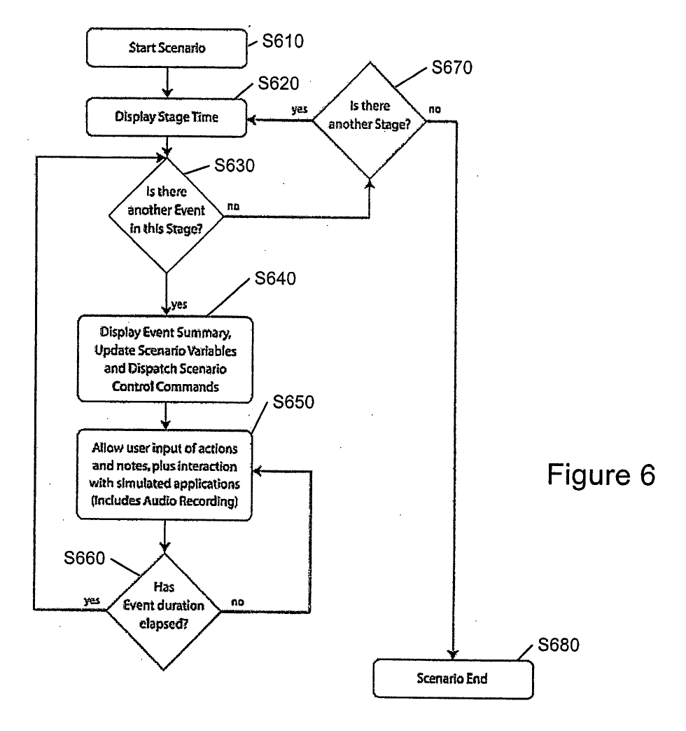

FIG. 6 shows a flow diagram of the flow of a scenario simulation using a simulator screen as discussed above with reference to FIG. 4. At s610 the scenario is started. The scenario time at the start of the stage is shown at s620. At s630 the scenario simulator checks to see if there are further unplayed events within the stage. If there are, then at s640 the event summary for the next event is shown in event details area 420, the scenario variables are updated, and the scenario time clock is updated accordingly. If the event contains any control commands, for example to update simulated applications, these control commands are dispatched at s640. During the simulation, events are revealed one at a time in the event details area 420 and the changing state of the simulated world in response to these events is displayed on the variable readouts at the top of the screen (in the scenario status area 410). Additionally, either a notification sound or an audible alert in the form of the computer speaking the event synopsis out loud may occur when the event is displayed in the event details area 420.

At s650, the personnel response is entered, together with any requested interaction with any simulated applications, and/or audio recording are received by the scenario simulator, and the response is recorded.

The variables associated with each event during design are also used to update the scenario. As the personnel react to the events, they type their actions and notes into the personnel response area 440. The responses may also be used to update the scenario, for personnel driven variables and for formula driven variables. If part of the personnel response to an event requires that they use an application, they can start a simulated version of that application from the scenario control area. They can then use the simulated application as they would use the real application. All actions and interaction with the simulated application are submitted to the training session for later assessment.

At s660 the scenario simulator then enters a loop of allowing personnel input until the duration of the event has expired, at which point no further input may be made in response to that event. Once the event duration has expired, the scenario simulator checks again for further events within the stage at s630. The simulator checks the scenario time, and when the scenario time corresponds to the scenario time set for that event, the next event is displayed and the system repeats s640, s650 and s660. This continues until all the events from the stage are completed, at which point the system checks for further stages at s670. The process of s630 to s660 is then repeated for any remaining stages within the scenario, until all stages have been played, at which point the scenario ends at s680.

Once a simulation session has been started for a given scenario, that scenario is said to be ‘in use’. Modifying a scenario that is in use is undesirable, as the session itself is tied to events within the scenario in order to provide such information as ‘correct procedure’ and event details. Changing this information can mean that a session no longer makes sense in the context of the new scenario details and/or structure.

Consequently, when an attempt is made to modify a scenario that is in use, the system warns that it has active sessions, and gives one of three options. These options are: duplicate scenario—which allows creation of a new scenario based on the existing ‘in use’ scenario, which can then be modified without invalidation of any existing sessions as the cloned scenario will have no sessions associated with it; delete sessions—which allows deletion of all sessions associated with a scenario; proceed—which is permitted for the sake of minor corrections and time adjustments to a scenario. If existing sessions may be invalidated, changing times and synopses of events will not invalidate the link between sessions, but it may still make the attempts of previous trainees seem incorrect in the context of the new changes.

Scenario Evaluation and Review

Once personnel have attempted a scenario and the scenario has been completed, that simulation session is ready to be marked by an assessor. The session marking feature can keep track of personnel performance as well as provide feedback to assist personnel in improving the quality of their responses to scenarios. The assessor can review the responses and observe the way responses to events are carried out, and if responses are carried out at all. The assessor can also observe behaviours of the personnel under pressure through responses to time critical tasks given in the events.

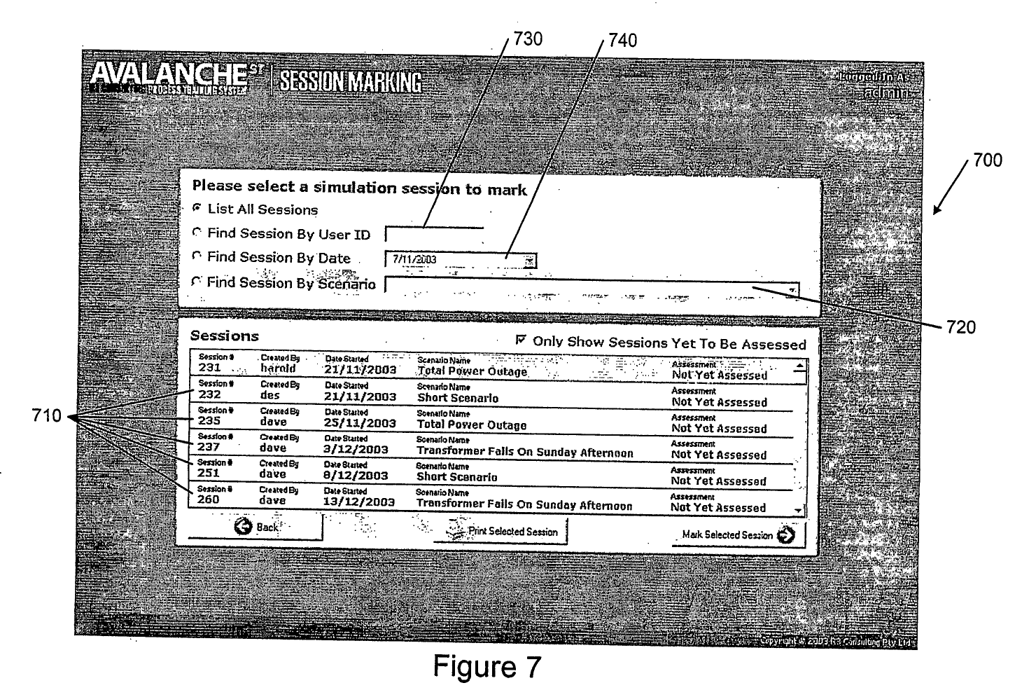

In one embodiment of the invention, the personnel responses are marked manually by an assessor using an evaluating component. Firstly, the assessor must choose which session is to be marked. FIG. 7 shows a session selection screen 700. The session selection screen 700 allows an assessor to easily find a particular session 710 for review. Sessions 710 are ordered by the date on which they were created; the oldest sessions 710 appear at the top of the list and the most recent sessions 710 appear at the bottom of the list. If there are a large number of unmarked sessions 710, it is useful to be able to search for a particular session 710, and so the session selection screen 700 allows the option of listing only particular sessions 710. The criteria for display can be by scenario name in scenario name field 720—by selecting a scenario name, an assessor is presented with a list of all unmarked sessions that were created for the specified scenario; created in field 730—by typing in a name, the assessor can filter the list of unmarked sessions to only include those created by particular personnel; and creation date by creation date field 740—using this, an assessor can select the date of a session and will be presented with the list of all unmarked sessions created on the specified date. The ‘created by’ selection is useful for the single-trainee version, if usernames are used to identify particular training groups, or in the multi-trainee version to examine the performance of a particular user. Other search criteria can be added e.g. administrator created “groups” of users or tiers.

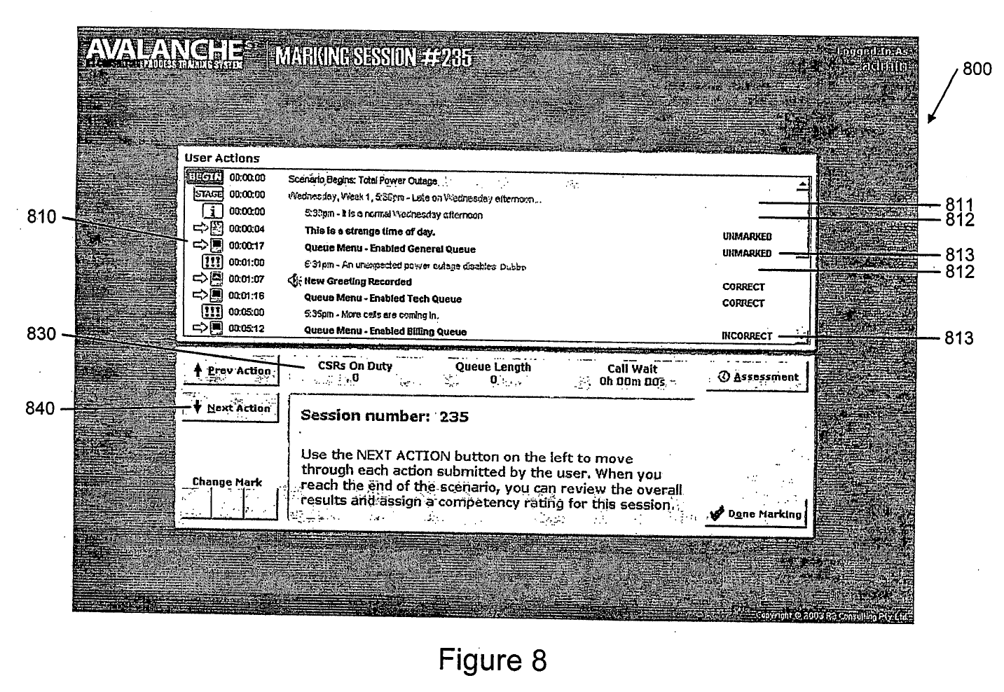

Once an assessor has chosen a session to mark, he enters the marking screen, which is shown in FIG. 8. The simulation history area 810 is almost identical to the equivalent area in the simulation player module. The difference being that the simulation history shows a colour scheme, which allows for the easy identification of user actions amongst simulator-generated events. It shows all stages 811, events 812 and personnel actions 813, along with other relevant occurrences during the session.

As an entry in the simulation history is selected, relevant information is displayed in the action details area 820. Also, the states of the “virtual world” variables at the time of the select event's occurrence are shown on the variable readouts 830 directly below the simulation history area 810.

The assessor can mark each individual personnel response in order, using the next action button 840 and, if a trainee's action is found, mark it, referring to “correct procedures” information if such information was added at the design stage, and continue until the whole session has been marked. Alternatively, at any point in this process, the assessor can click on an entry in the simulation history to jump directly to that entry.

Scenario assessment guidelines relating to the scenario as a whole may be input in the design stage, and provided to the assessor. The assessor can then review the assessment guidelines before marking a scenario.

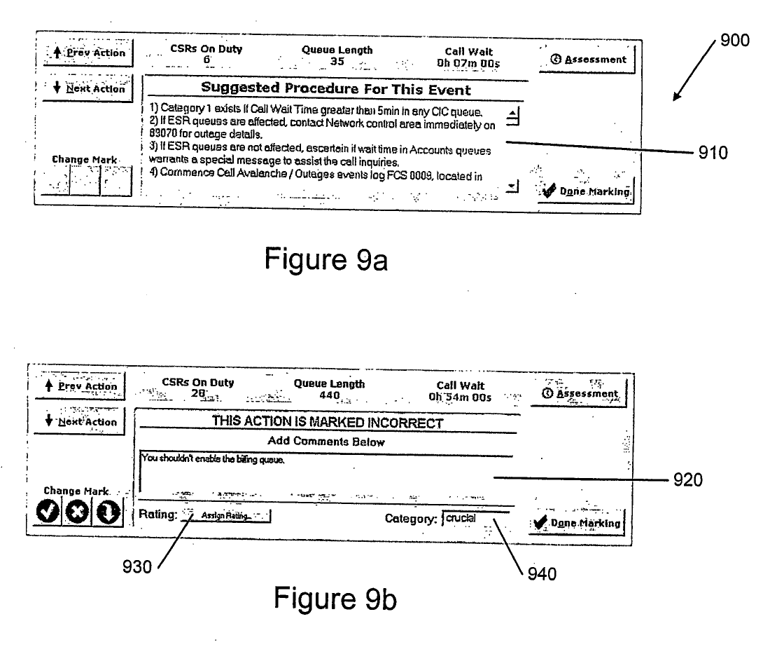

FIG. 9A shows a screen shot 900 for the marking of a response by personnel. In addition to the overall assessment guidelines, each individual event can contain details of the suggested procedures that trainees should take after such an event occurs. When marking a series of personnel actions in response to a particular event, the suggested procedure information can be easily referred to, simply by clicking on the event itself in the simulation history, and the suggested procedure is shown. As an unmarked action is encountered in the simulation history, the assessor is asked whether that action is correct or incorrect. They also have the option to ignore an action, if it that action has no relevance to the performance of the personnel. Once a mark has been assigned, the comment field area 920 is updated as shown in FIG. 9B. The mark having been given, further assessment is now possible for the action by adding comments, whereby if personnel have done something wrong the assessor is able to provide a comment on why the action wasn't correct. If the action is marked correct or ignored then a comment is not required; however, if the assessor feels an action of this sort is worthy of additional feedback, they can click an ‘add comment’ button and provide praise or other notes, in the displayed comments field 920.

Each action can optionally be assigned a rating. A rating consists of a maximum number of points allotted for the action in question, along with the number of points actually scored by the trainee.

As an example, personnel may have submitted an action that is mostly correct. In the assessment scheme for the scenario, this particular action (if totally correct) would be worth 5 marks out of a total of 100 for the whole scenario. However, due to the action only being mostly correct, the assessor may decide to rate this action 4 out of 5, while still marking the action CORRECT.

Similarly, an action that is mostly wrong may be marked INCORRECT, while still being given a rating of 1 out of 5.

To provide a rating for an action, the assessor simply clicks the ‘assign rating’ button 930 in the action panel and enters the rating.

In addition to ratings, the assessor has the option of assigning classification labels to each action that matches a category (sometimes referred to as a ‘weighting’) within their assessment scheme.

For example, consider an assessment scheme that requires that a trainee correctly perform all 6 out of 6 “crucial” tasks, at least 4 out of 5 “important” tasks and at least 2 out of 4 “useful” tasks.

As the assessor is marking a session by this scheme and encounters each action, one of the mentioned categories can be assigned if an action matches one from the assessment scheme. That is, if they encounter an action that was considered by the organization to be a crucial one, they can enter the category “crucial” by clicking the ‘assign category’ button and typing in ‘crucial’ in field 940. These categories are tallied during the final assessment.

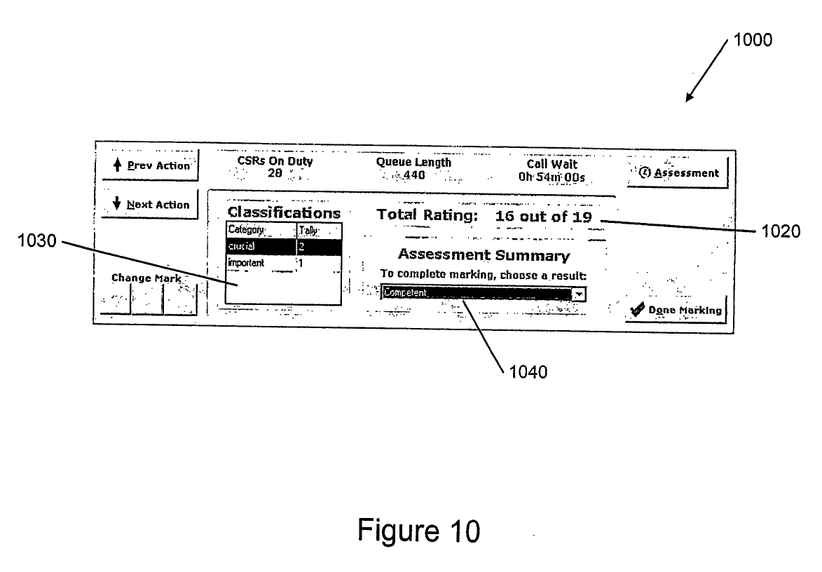

When the assessor reaches the end of the scenario session, they are presented with the final assessment panel shown in FIG. 10. This is provided by a certifying component. The panel 1000 shows the total sum of all ratings assigned to all actions (e.g. “52 out of 60”) at 1020, and a tallied list of the classification category labels provided (e.g. 6 instances of “Crucial, 4 instances of “Important”, 3 instances of “Useful”) at 1030. The total number of ‘correct’, ‘incorrect’ and ‘ignored’ actions may also be given on the panel.

The assessor can review this information, compare it to the scenario's assessment guidelines, and must then choose a final assessment for the session. In the present embodiment, the final assessment can be any of ‘Competent’; ‘Not Yet Competent’ or ‘Not Applicable’ and is assigned with drop down menu 1040. This list of options can be expanded to suit the needs of a particular organization training their personnel.

In alternate embodiments, some or all of the marking sections described above can be carried out automatically by the evaluating component and/or certifying component. For example, if model responses are stored and compared with those submitted by the personnel, and the personnel submitted responses are computer readable, then they may be marked automatically and the results stored for assessor verification. If some of the responses are computer assessable, then they can be assessed automatically, and the remaining ones flagged for review and marking by an assessor.

Additionally, the final assessment may be automatically generated, making use of a stored marking schedule, which is automatically compared to the achieved marks, and a competency assessment automatically generated.

In the case of multiple roles, in some training situations, it is necessary for the trainer and the assessor to be able to see which person was responsible for a particular response to an event. This can help identify which roles within the personnel's organization are functioning properly and which roles are causing problems in the processes. This can also help determine whether the people need improved training or whether the role descriptions themselves are flawed.

Once a session has been assessed, it can be printed out for archiving or for a hard-copy record of performance of personnel during the session. The session printout includes the scenario details, plus a detailed listing of the simulation history for that session. The category tally, total ratings and other assessment information are also included on the printout. Once a session has been marked, personnel are able to look back at the session and see what they did wrong and what they did right in the personnel review model.

Personnel can review their actions one by one, viewing the marks awarded for each response by the assessor or automated mark scheme in the simulation history list. They can see any ratings and categories assigned to the actions in the action panel at the bottom of the screen.

In a similar manner to the session marking module, personnel can jump directly to a particular action by clicking on that action in the simulation history list.

Sometimes, personnel may not be interested in the ratings and categories, and may only be interested in the comments written by the assessor, and the final assessment. In this case, they can use the ‘next comment’ and ‘previous comment’ buttons, which, rather than jumping between actions, jump to the next, or previous, action for which the assessor has provided a comment. When there are no more comments remaining, the ‘next comment’ button will take personnel to the end of the session, where they will be presented with their final assessment.

As personnel move to a given action, the action details area, similar to the display in FIG. 9B except without the ability to be modified, displays the assessment details for the selected action. The area displays: whether the action was marked ‘correct’, ‘incorrect’ or ‘ignored’; any comments provided for that action; any rating information provided for that action, and the classification category (if assigned by the assessor or automatic assessment) of this action.

Personnel can view their final assessment, by clicking on the “View Assessment” button to see the final assessment. In the same view as that given to the assessor in FIG. 10, personnel can view the tally of ‘correct’, ‘incorrect’ and ‘ignored’ actions, the sum of all ratings assigned to all actions, the tally of all category labels provided and the overall assessment (e.g. “Competent”). However, personnel have no way in which to alter their results. Personnel can print out these results, if desired.

As an organization runs training sessions using the scenario simulator, they are effectively gathering detailed information on the ability of their people to handle certain scenarios correctly. The reporting features of the system allow extraction and analysis of this information in useful ways, and allow generation of reports. While many customised reports may be created for particular organizations, the standard reports are available allowing print out of the assessment (and optionally, detailed simulation histories) for a range of simulation sessions.

Additionally, a number of filters (scenario name, date range, session owner) can be applied to describe exactly which session summaries they wish to print.

Alternatively a report creation tool allows the organisation to customise reports internally.

Personnel readiness analysis reports analyse which scenarios specific personnel are considered ready to handle in real life. The system generates a list of all scenarios, identifying the best assessment result the specified personnel have achieved for that scenario.

In the multi-user embodiment, a competency level will be given for each role that the specified personnel have been trained for.

It is also possible to provide a report showing each scenario, followed by the list of personnel who have reached each different competency level and, in the multi-user embodiment, which role they fulfilled to that competency level. Aside from personnel performance analysis, this report may be valuable to management in the case where a particular scenario arises in real life. In this case, this report may assist in selecting appropriate people to fill the roles of others who are absent at the time.

In alternative embodiments report records can be created in a variety of ways e.g. automatic email of results to users or publishing results on a corporate intranet site.

Although preferred embodiments have been illustrated in terms of training call centre personnel, it will be appreciated that the invention can be applied to any situation in which the responses of people to a progressing situation are required to be determined, marked or assessed.

The system and method of the invention have been described above purely by way of example, and various alterations, modifications and/or additions may be introduced into the particular construction, layout, look and feel and arrangement of the method and system of the invention described herein can be made within the scope and spirit of the invention, which is not limited to the above example, but also resides in any individual features and any combinations thereof.

1. A training simulation method for training personnel, the method including:
providing a simulated scenario to personnel, the scenario progressing in scenario time, and the scenario including a stage provided in real time, the stage including a plurality of simulated events provided in a sequence in real time at predetermined scenario times within the scenario; and
receiving responses to events from the personnel.

2. A method according to claim 1, wherein the simulated events include information describing the nature of the simulated event.

3. A method according to claim 1, wherein at least one of the simulated events includes at least one variable, each variable providing at least one parameter of the scenario.

4. A method according to claim 3, wherein the parameter is one chosen from the group consisting of: time of the event within the scenario, urgency of the event, suggested response to the event, and correct response to the event.

5. A method according to claim 3, wherein at least one variable of at least one of the plurality of events is at least partially determined by at least one response from the personnel to a previous event in the sequence.

6. A method according to claim 3, wherein at least one variable of at least one of the plurality of events is not determined by any of the responses from the personnel to any previous event in the sequence.

7. A method according to claim 6, wherein none of the plurality of events is determined by any of the responses from the personnel to any previous event in the sequence.

8. A method according to claim 1, including a plurality of stages, each representing a different period of scenario time, the events within each stage being provided in real time, the scenario time within the scenario being discontinuous between stages in the scenario.

9. A method according to claim 1, wherein the scenario includes a plurality of different roles, events within the scenario being assigned to at least one role, and events assigned to each role being provided to different personnel concurrently.

10. A method according to claim 9, wherein each role within the scenario provides a different combination of the plurality of events from the scenario.

11. A method according to claim 1, further including providing an application simulation of a software application or hardware device within the scenario.

12. A method according to claim 11, further including receiving personnel responses in a manner authentic to the software application or hardware device.

13. A method according to claim 1, wherein the responses from personnel are recorded together with the scenario time of each response within the scenario.

14. A method according to claim 13, further including evaluating the responses from the personnel after provision of the plurality of events.

15. A method according to claim 13, further including automatically conducting a comparison of the recorded responses with predetermined model responses to thereby provide an evaluation of the responses.

16. A method according to claim 15, wherein the comparison is conducted after the provision of the plurality of events.

17. A method according to claim 1, further including providing an output of the responses for review by an assessor, and recording the assessor's evaluation of the responses.

18. A method according to claim 14, further including certifying the personnel as meeting a predetermined level of competence, based on a comparison of the evaluated responses with at least one predetermined grading level.

19. A method according to claim 1, further including creating the plurality of events to be executed in a predetermined sequence at predetermined times according to scenario time within the scenario to produce a scenario.

20. A method according to claim 1, further including defining variables relating to the events provided to the personnel.

21. A method according to claim 5, wherein the sequence of events is determined based on previous responses to events.

22. A method according to claim 1, wherein events are provided in predetermined sequence.

23. A method according to claim 1, wherein events are created by personnel during the scenario.

24. A computer readable medium, including computer readable code for controlling a computer to carry out the method of claim 1.

25. A system for providing a training simulator for training personnel, the system including:
a processor; and
a storage medium, storing processor readable instructions for controlling the processor to carry out the method of claim 1.

26. A method of designing a training scenario for provision for training personnel, the method including creating a plurality of events to be executed in a predetermined sequence at predetermined times according to a clock within the scenario, to produce the scenario to receive responses from personnel thereto, assigning a time for each of the events to occur within the scenario, and storing the designed scenario.

27. A method according to claim 26, wherein the plurality of events are created by defining a description of each event for provision to personnel, together with a plurality of variables defining effects of the event on the scenario.

28. A training simulation system for training operational service unit personnel, the system including:
a timing component to provide a real time clock, giving scenario time within a scenario, and time stamps according to that clock;
a scenario simulating component to provide a simulated scenario to personnel, the scenario including a stage including a plurality of simulated events to be provided in a predetermined sequence in real time at predetermined scenario times according to the clock; and
an input component to receive personnel responses to the events.

29. A system according to claim 28, further including a recording component to record the responses from the personnel together with time stamps from the timing component corresponding to the scenario times of responses according to the clock.

30. A system according to claim 28, wherein the scenario simulating component is arranged to provide the simulated event for display to the personnel.

31. A system according to any one of claims claim 28, wherein the events include a description of the simulated event.

32. A system according to claim 28, wherein the events include variables, each variable providing at least one parameter of the scenario.

33. A system according to claim 32, further including a processing component to process at least one of the responses and at least partially determine at least one variable in at least one subsequent event in the sequence on the basis of said response.

34. A system according to claim 28, further including an application simulation component to provide a simulation of a software application or hardware device.

35. A system according to claim 34, wherein the input component is arranged to receive personnel responses input in a manner authentic to the software application or hardware device.

36. A system according to claim 28, further including a storage component to store instructions to produce the series of events of a simulated scenario in real time according to the clock.

37. A system according to claim 28, wherein the scenario simulating component is arranged to provide a plurality of stages, each representing a different period of scenario time, the events within each stage to be provided in real time, and a discontinuity of scenario time to be provided between different stages.

38. A system according to claim 28, wherein the components are provided on a computer, laptop, palm held device or other similar computing device.

39. A system according to claim 28, wherein the scenario simulating component is arranged to provide the plurality of events to a plurality of personnel concurrently, according to one or more roles assigned to each event and the personnel.

40. A system according to claim 28, wherein the scenario simulating component provides a virtual scenario to the personnel.

41. A system according to claim 28, further including an evaluating component to facilitate evaluation of the responses from the personnel after provision of the events.

42. A system according to claim 41, wherein the evaluating component is arranged to provide a comparison of the real time responses with predetermined model responses and thereby to provide an evaluation of the real time responses.

43. A system according to claim 41, wherein the evaluating component is arranged to provide an output of the real time responses for review by an assessor, and is arranged to provide a means of recording the assessor's evaluation of the responses.

44. A system according to claim 41, further including a certifying component to certify the personnel as meeting a predetermined level of competence, based on a comparison of the evaluated responses with at least one predetermined grading level.

45.-46. (canceled)
